(19) United States
(12) Patent Application Publication
(10) Pub. No.: US 2013/0012102 A1
(43) Pub. Date: Jan. 10, 2013

(54) POLISHING SLURRY AND POLISHING METHOD THEREFOR

(76) Inventors: Yasuhide Yamaguchi, Shinagawa-ku (JP); Mikimasa Horiuchi, Shinagawa-ku (JP)

(21) Appl. No.: 13/634,939

(22) PCT Filed: Nov. 22, 2010
(86) PCT No.: PCT/JP2010/070795

§ 371 Date: Sep. 14, 2012

(30) Foreign Application Priority Data
Apr. 9, 2010 (JP) 2010-090837

(51) Int. Cl. C09K 3/14; B24B 37/00

(52) U.S. Cl. 451/36; 51/309

(57) ABSTRACT

The present invention provides a polishing technique which enables polishing of silicon carbide, which is difficult to be polished, with high efficiency and high surface accuracy. The present invention relates to a polishing slurry for polishing a substrate, which comprises abrasive particles containing manganese oxide as a main component and in which the content of the abrasive particles is less than 10% by weight based on the polishing slurry. The polishing slurry of the present invention has a pH of preferably 7 or more. It is particularly preferable to use manganese dioxide as abrasive particles. The polishing slurry of the present invention is suitable for a substrate of silicon carbide.

### BACKGROUND OF THE INVENTION

1. Field of the Invention

The present invention relates to a polishing slurry containing manganese oxide as a main component and a method for polishing therewith, and particularly to a polishing slurry suitable for polishing silicon carbide.

2. Description of the Related Art

Recently polishing has been often used as means for surface processing of constituent materials of various electronic and electric products. In such polishing, surfaces of objects to be polished, such as substrates, are polished with abrasive particles dispersed in an aqueous liquid, namely, a polishing slurry. It is known that the amount of polishing at the time of polishing depends on the concentration of abrasive particles.

A larger amount of abrasive particles in polishing increases the contact frequency between abrasive particles and the surface of the object to be polished, and so the abrasive particles cut away more substances from the surface of the object to be polished, thereby increasing polishing rates. Controlling the concentration of abrasive particles in polishing has been applied to polishing slurries with abrasive particles such as silicon oxide (SiO₂) and aluminum oxide (Al₂O₃). It is common technical knowledge that the concentration of abrasive particles in such a polishing slurry, i.e., polishing slurry concentration, is set at 10% by weight to 20% by weight to carry out polishing. It has also been proposed that even in the case of polishing with, for example, manganese oxide as abrasive particles, the polishing slurry concentration is set at 10% by weight to 20% by weight (See Patent Document 1, Patent Document 2).

Recently, silicon carbide (SiC) has been attracting attention as a substrate material for power electronics semiconductors and white LEDs, and silicon carbide is known to be difficult to be machined due to its extremely high hardness. Given that, silicon carbide is polished with silicon oxide abrasive particles having excellent polishing properties. However, although the surface that has been polished has high surface accuracy, the polishing rate is low, and it is said that efficient polishing is difficult. Thus at present there is a strong demand for polishing technique capable of rapidly polishing even difficult-to-machine materials such as silicon carbide while achieving desired surface accuracy.

### PRIOR ART DOCUMENT

### Patent Documents

[Patent Document 1] Japanese Patent Application Laid-Open No. 9-22888

[Patent Document 2] Japanese Patent Application Laid-Open No. 10-60415

### SUMMARY OF THE INVENTION

### Problems to be Solved by the Invention

The present invention has been made under the above circumstances and provides a polishing technique capable of increasing polishing rates in polishing with a polishing slurry in which manganese oxide is used as abrasive particles. An object of the present invention is to provide a polishing technique capable of polishing, in particular, an object to be polished having high hardness and difficult to be machined, such as silicon carbide (SiC), at high polishing rates with good surface accuracy.

### Means for Solving the Problems

The present inventors have conducted intensive studies on a polishing slurry prepared by dispersing manganese oxide in an aqueous liquid as abrasive particles, and have found that even at low concentration of abrasive particles, the polishing rate can be increased by chemical properties of the abrasive particles, and thus have accomplished the present invention.

The present invention relates to a polishing slurry for polishing a substrate, which comprises abrasive particles containing manganese oxide as a main component and in which the content of the abrasive particles is less than 10% by weight based on the polishing slurry. Although the content of the abrasive particles in the polishing slurry of the present invention is as low as less than 10% by weight, when manganese oxide is used as abrasive particles, the polishing rate is high and polishing offers a smooth polishing surface. The present invention is capable of forming a polishing surface having good surface accuracy at high polishing rates even at a polishing particle concentration lower than that of a conventional polishing slurry containing silicon oxide (SiO₂). The polishing slurry of the present invention enables polishing of an object to be polished having high hardness and difficult to be machined, such as silicon carbide (SiC), at high polishing rates with good surface accuracy. In the present invention, abrasive particles containing manganese oxide as a main component mean that abrasive particles contain 90% by weight or more of manganese oxide.

When the content of the abrasive particles in the polishing slurry of the present invention exceeds 10% by weight, the polishing rate will increase, but the polishing surface will have low surface accuracy. The lower limit of the content is 0.1% by weight or more. This is because when the content is less than 0.1% by weight, the polishing rate is low and practical polishing is difficult. The content of the abrasive particles is more preferably 0.5% by weight to 5% by weight. The aqueous liquid in the polishing slurry of the present invention means water or a mixture of water and at least one organic solvent soluble in water mixed within the soluble range, containing at least 1% of water. Examples of organic solvents include alcohol and ketone.

Examples of alcohols that can be used in the present invention include methanol (methyl alcohol), ethanol (ethyl alcohol), 1-propanol (n-propyl alcohol), 2-propanol (iso-propyl alcohol, IPA), 2-methyl-1-propanol (iso-butyl alcohol), 2-methyl-2-propanol (tert-butyl alcohol), 1-butanol (n-butyl alcohol) and 2-butanol (sec-butyl alcohol). Examples of polyhydric alcohol include 1,2-ethanediol (ethylene glycol), 1,2-propanediol (propylene glycol), 1,3-propanediol (trimethylene glycol) and 1,2,3-propanetriol (glycerol)

Examples of ketones that can be used in the present invention include propanone (acetone) and 2-butanone (methyl ethyl ketone, MEK). In addition, tetrahydrofuran (THF), N,N-dimethylformamide (DMF), dimethyl sulfoxide (DMSO) and 1,4-dioxane may also be used.

The polishing slurry of the present invention preferably has a pH of 7 or more. A pH of 7 or more offers a high polishing rate with maintaining good surface accuracy. More specifically, when the pH is 7 or more and the object to be polished is silicon carbide, polishing with a surface roughness Ra of the polishing surface of 0.2 nm or less at a polishing rate of 100 nm/hr or more is achieved. The upper limit of pH is 13. When the pH is more than 13, chemical properties of abrasive particles begin to change, that is, action of etching of silicon carbide due to manganese oxide begins, and the polishing surface is more likely to be roughened. The pH is preferably 7 to 12. When adjusting the pH, chemicals for that are not particularly limited. To suppress the negative effect on the object to be polished, however, potassium salts and ammonium salts are preferably used, and potassium salts are more preferably used.

In the polishing slurry of the present invention, manganese dioxide is preferably used as manganese oxide. Using manganese dioxide as abrasive particles offers a high polishing rate with maintaining good surface accuracy even when silicon carbide is the object to be polished. When manganese dioxide as abrasive particles is dispersed in water, the resultant has a pH of 5 to 6, and so for adjusting the pH to 7 or more, an alkaline chemical is preferably added thereto.

The particle size of manganese oxide that serves as abrasive particles is not particularly limited. To achieve good surface accuracy, 50% diameter D₅₀ in volume-based cumulative fractions of particle diameter distribution measured with a laser diffraction/scattering method is preferably 1 μm or less, more preferably 0.5 μm or less.

In the present invention, objects to be polished are not particularly limited. Materials having high hardness and difficult to be machined are suitable as the object to be polished. Examples thereof include aluminum oxide (Al₂O₃), gallium nitride (GaN) and silicon carbide (SiC). It is particularly suitable that the object to be polished is silicon carbide (SiC).

### Effect of the Invention

As described above, the polishing slurry of the present invention enables polishing of an object to be polished having high hardness and difficult to be machined, such as silicon carbide (SiC), at high polishing rates with good surface accuracy.

### BRIEF DESCRIPTION OF THE DRAWINGS

FIG. 1 is a graph illustrating the relation between slurry concentrations and polishing rates relative to the amount of abrasive particles.

### EMBODIMENTS FOR CARRYING OUT THE INVENTION

Embodiments of the present invention will be described with reference to Examples and Comparative Examples.

### Examples 1 to 4

In Examples 1 to 4, MnO₂ having an average particle size D₅₀ of 0.5 μm was used as abrasive particles, and the particles were dispersed in water as an aqueous liquid to prepare polishing slurries having a respective slurry concentration shown in Table 1. The polishing slurries of Examples 1 to 4 had a pH of 7.8. The average particle size D₅₀ of MnO₂ was measured with Laser Diffraction/Scattering Method Particle Size Distribution Analyzer (LA920 made by Horiba, Ltd.).

Silicon carbide single crystal substrates were polished with the respective polishing slurries to examine their polishing properties. The silicon carbide single crystal substrates which were the object to be polished were SiC single crystal (6H structure) of 2 inches in diameter and 330 μm in thickness. The polishing surface was on axis (the wafer surface cut perpendicularly to the crystal axis). Before polishing, the average surface roughness in a 10 μm×10 μm area of the surface to be polished of the substrate was measured with AFM (Atomic force microscopy: NanoScope IIIa made by Veeco Instruments Inc.). As a result, Ra was 2.46 nm.

Referring to the polishing condition, a silicon carbide single crystal substrate placed on a polishing pad (SUBA400 made by Nitta Haas Incorporated) was polished with the respective polishing slurries of Examples 1 to 4 at a polishing load of 250 g/cm² for 3 hours. After the polishing, the polishing surface was washed with water to remove slurry attached and dried. The surface roughness of the dried polishing surface was measured at 5 random points by AFM. The results of the measurement of the average surface roughness (10 μm×10 μm area) are shown in Table 1. The weight of the silicon carbide single crystal substrate was measured before and after the polishing, and the weight difference was determined to be the amount of polishing, and with this, the polishing rate was calculated from the surface area and the specific gravity of the substrates. The polishing rates are shown in Table 1.

For comparison, polishing slurries having a slurry concentration of 10% by weight or more were prepared (Comparative Examples 1 to 3) and polishing slurries with conventional commercially available colloidal silica (made by Fujimi Incorporated, Compol 80 (silicon oxide (SiO₂) abrasive)) were prepared (Comparative Examples 4 to 10). The colloidal silica had an average particle size D₅₀ of 0.10 μm. In Comparative Examples 4 to 10, colloidal silica was dispersed in water as an aqueous liquid to prepare polishing slurries having a respective slurry concentration shown in Table 1.

Polishing properties were examined in the same conditions as in the above Examples 1 to 4. The polishing slurries of Comparative Examples 1 to 3 had a pH of 8.2 and the polishing slurries of Comparative Examples 4 to 10 had a pH of 8.7 to 9.1.

TABLE 1

| | | Slurry | Polishing | Surface |
|---|---|---|---|---|
| | Abrasive | concentration | rate | roughness Ra |
| | particles | (wt %) | (nm/hr) | (nm) |
| Example 1 | MnO₂ | 1 | 105 | 0.13 |
| Example 2 | | 2 | 120 | 0.16 |
| Example 3 | | 5 | 150 | 0.17 |
| Example 4 | | 7 | 165 | 0.16 |
| Comparative | MnO₂ | 10 | 195 | 0.21 |
| Example 1 | | | | |
| Comparative | | 20 | 225 | 0.24 |
| Example 2 | | | | |
| Comparative | | 30 | 255 | 0.36 |
| Example 3 | | | | |
| Comparative | SiO₂ | 1 | 18 | 0.21 |
| Example 4 | | | | |
| Comparative | | 2 | 39 | 0.26 |
| Example 5 | | | | |
| Comparative | | 5 | 69 | 0.30 |
| Example 6 | | | | |
| Comparative | | 7 | 120 | 0.32 |
| Example 7 | | | | |
| Comparative | | 10 | 180 | 0.36 |
| Example 8 | | | | |
| Comparative | | 20 | 270 | 0.41 |
| Example 9 | | | | |
| Comparative | | 30 | 420 | 0.49 |
| Example 10 | | | | |

As shown in Table 1, it has been found that in Examples 1 to 4, the substrates were polished with a surface accuracy of the polishing surface of 0.2 nm or less even at a polishing particle concentration of less than 10% by weight, and the polishing rates were much higher value than those with SiO₂. It has also been found that although the polishing rate suddenly declined at a slurry concentration of less than 10% by weight in the case of SiO₂, high polishing rates were achieved even at a slurry concentration of less than 10% by weight in the case of MnO₂.

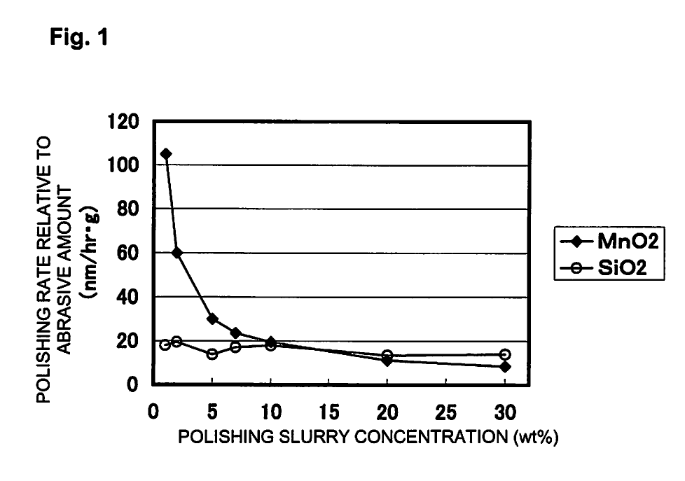

FIG. 1 shows a graph illustrating the relation between polishing slurry concentrations and polishing rates relative to the amount of abrasive particles. For the amount of abrasive particles, the amount of abrasive particles contained in 100 g of the respective polishing slurries was determined to be the total weight, and values obtained by dividing the polishing rate value shown in Table 1 by the total weight of the abrasive particles were determined to be the polishing rate (nm/hr·g) relative to the amount of abrasive particles. As is apparent from FIG. 1, it has been found that while the polishing rate relative to the amount of abrasive particles based on the slurry concentration changes little in the case of SiO₂, the polishing rate relative to the amount of abrasive particles increases in the case of MnO₂ when the slurry concentration is low. Specifically, when the slurry concentration was 1% by weight, the polishing rate with MnO₂ was 5 times that with SiO₂.

Next the results of examining the pH of polishing slurries will be described. Table 2 shows the result of studying polishing properties with adjusting the pH of polishing slurries having a slurry concentration of 1% by weight and 5% by weight. In Table 2, Examples 5 to 8 and Comparative Examples 11, 12 show the cases with MnO₂, and Comparative Examples 13 to 16 show the cases with SiO₂. The conditions of abrasive particles MnO₂ and SiO₂ were the same as those in the above Example 1 and Comparative Example 4. Also polishing properties were evaluated in the same manner.

The pH was adjusted with sulfuric acid or potassium hydroxide.

TABLE 2

| | | | | | Surface |
|---|---|---|---|---|---|
| | | Slurry | | Polishing | roughness |
| | Abrasive | concentration | | rate | Ra |
| | particles | (wt %) | pH | (nm/hr) | (nm) |
| Example 5 | MnO₂ | 1 | 9.2 | 131 | 0.13 |
| Example 6 | | | 11.6 | 225 | 0.15 |
| Example 7 | | 5 | 10.0 | 180 | 0.13 |
| Example 8 | | | 12.3 | 261 | 0.20 |
| Comparative | MnO₂ | 1 | 3.8 | 80 | 0.31 |
| Example 11 | | | | | |
| Comparative | | 5 | 4.1 | 91 | 0.27 |
| Example 12 | | | | | |
| Comparative | SiO₂ | 1 | 5.6 | 10 | 0.41 |
| Example 13 | | | | | |
| Comparative | | | 10.9 | 29 | 0.35 |
| Example 14 | | | | | |
| Comparative | | 5 | 7.6 | 46 | 0.55 |
| Example 15 | | | | | |
| Comparative | | | 12.1 | 101 | 0.47 |
| Example 16 | | | | | |

As the results in Table 2 show, it has been found that in the case of MnO₂ the polishing rate is very high when the pH is adjusted to 7 or more. For example, a polishing slurry containing 5% by weight of MnO₂ and having a pH of 12.3 had a polishing rate similar to that of a SiO₂ polishing slurry at a concentration of 20% by weight (see Table 1, Comparative Example 9). While the surface roughness Ra was as high as 0.41 nm in Comparative Example 9, excellent surface accuracy was achieved in Example 8 with a surface roughness Ra of 0.2 nm.

### INDUSTRIAL APPLICABILITY

The present invention enables highly efficient, high speed polishing of difficult-to-machine materials such as silicon carbide with high surface accuracy.

1. A polishing slurry for polishing a substrate, which comprises abrasive particles containing manganese oxide as a main component and in which the content of the abrasive particles is less than 10% by weight based on the polishing slurry.

2. The polishing slurry according to claim 1, having a pH of 7 or more.

3. The polishing slurry according to claim 1, wherein the manganese oxide is manganese dioxide.

4. The polishing slurry according to claim 1, wherein the substrate comprises silicon carbide.

5. A method for polishing a substrate, comprising polishing the substrate with a polishing slurry which comprises abrasive particles containing manganese oxide as a main component and in which the content of the abrasive particles is less than 10% by weight based on the polishing slurry.

6. The method for polishing a substrate according to claim 5, wherein the pH of the polishing slurry is kept at 7 or more in the polishing.

7. The method for polishing a substrate according to claim 5, wherein the substrate comprises silicon carbide.

8. The polishing slurry according to claim 2, wherein the manganese oxide is manganese dioxide.

9. The polishing slurry according to claim 2, wherein the substrate comprises silicon carbide.

10. The polishing slurry according to claim 3, wherein the substrate comprises silicon carbide.

11. The polishing slurry according to claim 8, wherein the substrate comprises silicon carbide.

12. The method for polishing a substrate according to claim 6, wherein the substrate comprises silicon carbide.
